(19) United States
(12) Patent Application Publication
(10) Pub. No.: US 2008/0098344 A1
(43) Pub. Date: Apr. 24, 2008

(54) SOFTWARE INSPECTION MANAGEMENT TOOL

(75) Inventor: Jerry L. Piatt, Northridge, CA (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/539,256

(22) Filed: Oct. 6, 2006

(51) Int. Cl. G06F 9/44

(52) U.S. Cl. 717/101

(57) ABSTRACT

A software inspection management tool for monitoring inspection rates of code, the tool including: a display device for displaying a primary window having a plurality of functions; a first function being used for defining a new package by; a second function being used for opening an existing package; an inspection rate monitor for displaying elapsed time of inspection by a user; and a viewer window having two panes for examining the code, the first pane including a table view of items being inspected and the second pane including a table of comments to be made concerning the items being inspected; wherein the elapsed time is compared to a predetermined minimum and maximum range of permitted inspection time predefined in a preference dialog window; and wherein color modifications of the elapsed time occur in accordance with the user's inspection rate progress.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to software development, and particularly to a software inspection management tool monitoring inspection rates.

2. Description of Background

A very time consuming part of software development is the process known as code inspection. In this process, the developer who has written some new code or changed some existing code calls a meeting of knowledgeable, interested parties to review the developer's work and to look for potential issues. In many companies, this process is quite formalized with very strict rules about the number and roles of people attending the inspection, and the manner in which the results of this inspection are reported. The time invested in the actual code inspection is productive and can be tied directly to the quality of the work product, however the time spent in the preparation and administration of inspections is generally an undesirable overhead. The following are the general steps followed, each of which takes productive time away from the developer and/or other code inspectors.

The developer acquires a copy of the new/changed code from the source library and stores such code locally in a format convenient for distribution to the code inspectors. The developer then forwards the code to the inspectors prior to the inspection date. The inspectors keep track of these listings until the inspection is held.

Formal inspection processes call for a close accounting of the quantity of code to be inspected. Typically, the moderator tabulates the number of lines. If all the programs being inspected are new, then the developer has only to edit each program and count the total lines. Of course, in some languages, such as Java, a developer might have as much as 60% comment lines in the code. Counting these comment lines can skew their inspection efficiency rating severely. Usually, however, the inspectors inspect only changed code. In this case, the moderator edits each and every source member being inspected and manually counts the number of changed lines.

Moderators are also charged with recording the comments and defects discovered during the inspection process since it is deemed easier than having each individual inspector keep track of their own comments and get the results to the author at the end of the inspection. This leads to some problems, however, when the moderator misinterprets the comments or has difficulty keeping up and misses something.

A key measure of inspection efficiency is inspection rate. If an inspection covers too much code in too little time, it is unlikely that it is a thorough inspection. Because one doesn't know how long the inspection will take until it is complete, the inspection rate cannot be computed until it is too late to do anything about it. This can necessitate a re-inspection by one or more inspectors. These are all issues encountered by software professionals while conducting one or more inspections on various code.

Considering the limitations of the aforementioned methods, it is clear that there is a need for an efficient software inspection management tool monitoring inspection rates.

### SUMMARY OF THE INVENTION

The shortcomings of the prior art are overcome and additional advantages are provided through the provision of a software inspection management tool for monitoring inspection rates of code, the tool comprising: a display device for displaying a primary window having a plurality of functions; a first function being used for defining a new package by inputting an item type, an item language, an item name, and a code status; a second function being used for opening an existing package and displaying a plurality of source listings relating to the existing package; a third function being used for transmitting the new package or the existing package; a fourth function for importing and exporting the new package or the existing package; an inspection rate monitor for displaying elapsed time of inspection by a user, the inspection rate monitor having a pause button, a resume button, a complete button, a total lines inspected indication, and a total lines remaining to be inspected indication; and a viewer window having two panes for examining the code, the first pane including a table view of items being inspected and the second pane including a table of comments to be made concerning the items being inspected; wherein the elapsed time is compared to a predetermined minimum and maximum range of permitted inspection time predefined in a preference dialog window; and wherein color modifications of the elapsed time occur in accordance with the user's inspection rate progress.

Additional features and advantages are realized through the techniques of the present invention. Other embodiments and aspects of the invention are described in detail herein and are considered a part of the claimed invention. For a better understanding of the invention with advantages and features, refer to the description and the drawings.

### Technical Effects

As a result of the summarized invention, technically we have achieved a solution that provides for a software inspection management tool monitoring inspection rates.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a diagram showing a primary window that displays a list of predefined packages, according to the exemplary embodiments of the present invention;

FIG. 2 illustrates one example of a diagram illustrating a new package dialog box being defined, according to the exemplary embodiments of the present invention;

FIG. 3 illustrates one example of a diagram showing a package contents list window, according to the exemplary embodiments of the present invention;

FIG. 4 illustrates one example of a diagram illustrating an item dialog box being defined, according to the exemplary embodiments of the present invention;

FIG. 5 illustrates one example of a diagram illustrating an inspection rate monitor, according to the exemplary embodiments of the present invention;

FIG. 6 illustrates one example of a diagram showing a document viewer box in “View Changed” mode with comments, according to the exemplary embodiments of the present invention;

FIG. 7 illustrates one example of a diagram showing a dialog box with a first preference tab, according to the exemplary embodiments of the present invention;

FIG. 8 illustrates one example of a diagram showing a dialog box with a second preference tab, according to the exemplary embodiments of the present invention;

FIG. 9 illustrates one example of a diagram showing a dialog box of a File Transfer Protocol (FTP) download dialog, according to the exemplary embodiments of the present invention;

FIG. 10 illustrates one example of a diagram showing a dialog box of a comment dialog, according to the exemplary embodiments of the present invention;

FIG. 11 illustrates one example of a diagram illustrating a plurality of inspection rate monitors keeping track of a plurality of marked items, according to the exemplary embodiments of the present invention;

FIG. 12 illustrates one example of a system block diagram showing the system components used to run the inspection tool software.

### DETAILED DESCRIPTION OF THE INVENTION

One aspect of the exemplary embodiments is a system having an inspection process manager, which streamlines the drudgework in preparing for and holding a code inspection. In another aspect of the exemplary embodiments, the inspection process management tool provides the originating developer with a method for gathering the inspection materials, packaging them, and sending them to the inspection participants. In yet another exemplary embodiment, the inspection management tool provides the inspectors with tools for viewing the documents and recording their defects and comments, themselves. As a result, the moderator benefits from the tool's ability to count changed code lines and continuously monitor elapsed inspection time against the line count and previously defined minimum and maximum inspection rates.

The inspection tool provides, among other aspects, the ability to define new inspection packages including, for example, the following characteristics: (1) Package name, (2) Type (Code, Document, Test Scenario, etc.), (3) Language (Assembler, C/C++, Java, English, etc.), (4) Status (Planning, Pending, Rework, Complete, etc.), (5) Date created, and (6) Date last modified.

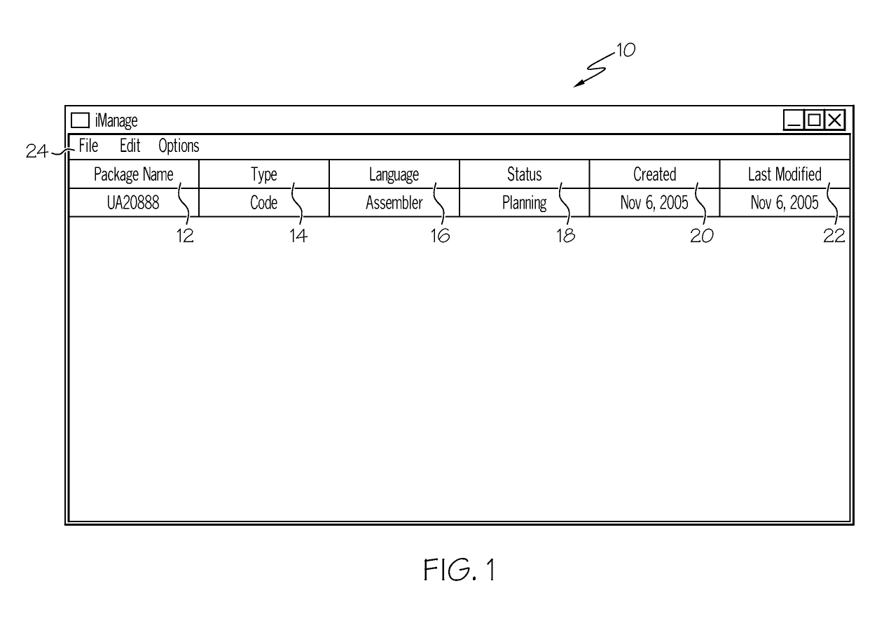

Referring to FIG. 1, one example of a diagram showing a primary window that displays a list of predefined packages, according to the exemplary embodiments of the present invention is illustrated. The primary window 10 has a toolbar 24 with typical commands, such as File, Edit, and Options. Below the toolbar 24, the user of the inspection management tool has several types of information displayed. Specifically, the user is informed of the package name 12, the type of code 14, the predominant language of items in the package 16, the status of the package 18, the date the package was created 20, and the date the package was last modified 22. The primary window 10 is the first window displayed when the inspection management program is commenced by a user. From this window 10, a user can define a new package, open an existing package, email a package to one or more recipients, and import or export packages. Existing packages in the list can be edited to change attributes established when the attributes were defined. The attributes can be removed entirely or archived to a predefined location, if desired by a user. The inspection management tool is not limited to the exemplary functions and information displayed in FIG. 1.

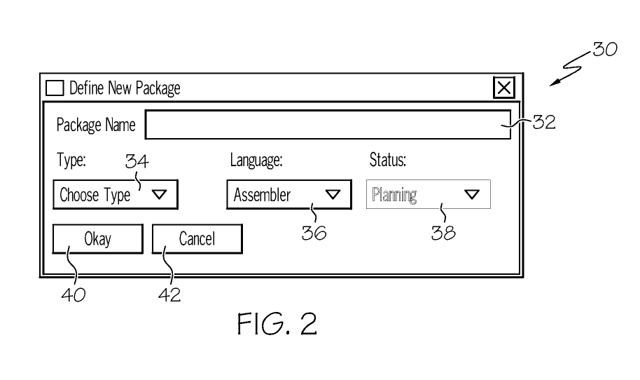

Referring to FIG. 2, one example of a diagram illustrating a new package dialog box being defined, according to the exemplary embodiments of the present invention is illustrated. The new package dialog box 30 includes a package name entry 32, a choose type pull-down menu 34, a programming language pull-down menu 36, and a status menu 38. The new package dialog box 30 also includes an “okay” button 40 and a cancel button 42. The inspection management tool is not limited to the exemplary functions and information displayed in FIG. 2.

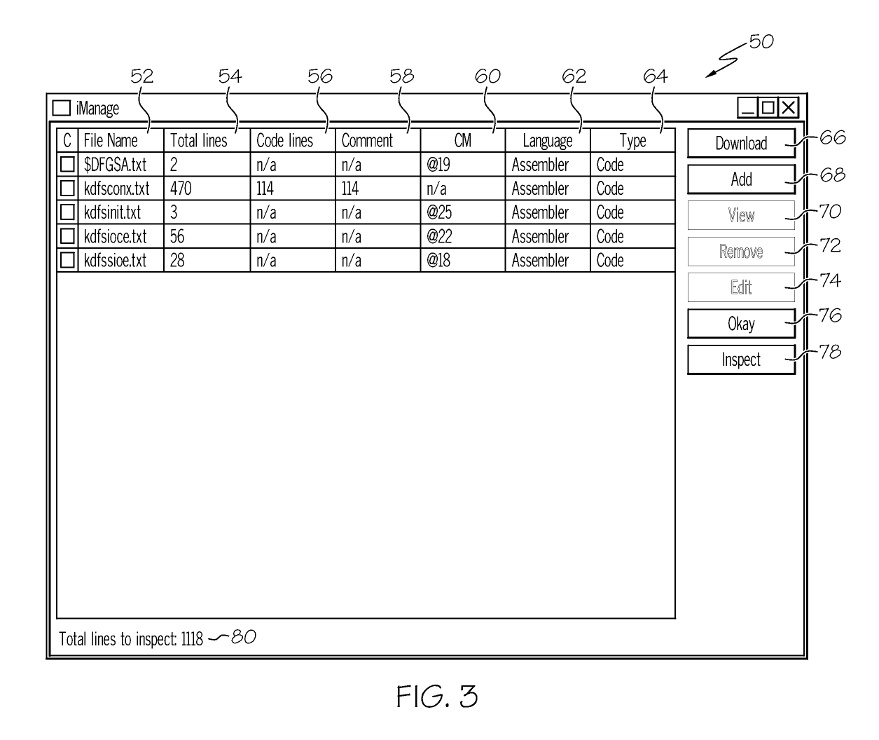

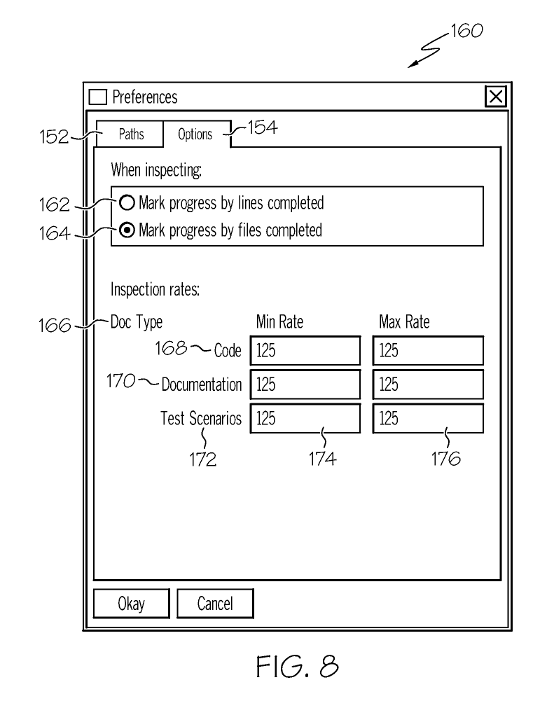

Referring to FIG. 3, one example of a diagram showing a package contents list window, according to the exemplary embodiments of the present invention is illustrated. The package contents list window 50 includes various types of information displayed to the user. Specifically, the user is informed of the file name 52, the total number of lines in the item 54, the actual number of code lines 56, the comment lines 58, the indicator used in this item to indicate a changed line 60, the language of the inspection item 62, and the type of inspection item 64 (whether it is code, documentation, test scenario, cover letter, etc.). The user is also able to use various functions on the package contents list window 50. These functions include download 66, add 68, view 70, remove 72, edit 74, okay 76, and inspect 78. In addition, at the bottom portion of the package contents list window 50, the user is informed of the total lines to inspect 80. It is noted that one may display the above information in any order desired. Moreover, one skilled in the art may be able to identify several additional functions to add to the package contents list window 50 and display a number of other types of related information. Opening a package reveals the various source listings contained within it and provides the ability to edit the list by adding, removing or editing entries to it. This view also provides access to a built-in FTP download-only client (shown in FIG. 8 described below) for use in retrieving listings from remote locations. The add function 68 first displays a standard file chooser, allowing a user to locate the file on local or network-connected drives.

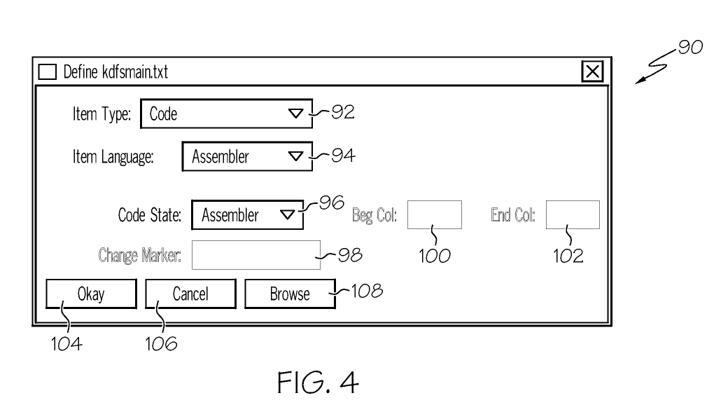

Referring to FIG. 4, one example of a diagram illustrating an item dialog box being defined, according to the exemplary embodiments of the present invention is illustrated. The item dialog box 90 includes various types of information displayed to the user. Specifically, this information includes the item type pull-down menu 92, the item language pull-down menu 94, a code state pull-down menu 96, a beginning column entry 100, an end column entry 102, a change marker entry 98, an okay button 104, a cancel button 106, and a browse button 108. The item dialog box 90 collects other information about the new source listing. However, aside from collecting the document type and language, dialog box 90 also gathers information as to whether the new document represents entirely new code or changed code (Code State). If the user specifies “New,” every line in the document is counted and displayed under “Total lines.” If “Changed” is selected the user is given the opportunity to supply the change marker used to identify the changed lines. If necessary, the user may also specify a beginning and ending column to search between when looking for the change marker. The provided browse button opens the inspection item in a text editor, giving the user an opportunity to determine what change marker was used. When modules containing all new code are added, lines are counted and totals tabulated for both code lines and comment lines. For changed code, only the total lines is computed and displayed. In this case “Total lines” really means total lines being inspected. Comment lines are not differentiated from code lines, in this case and the fields for code lines and comment lines are marked “n/a” accordingly.

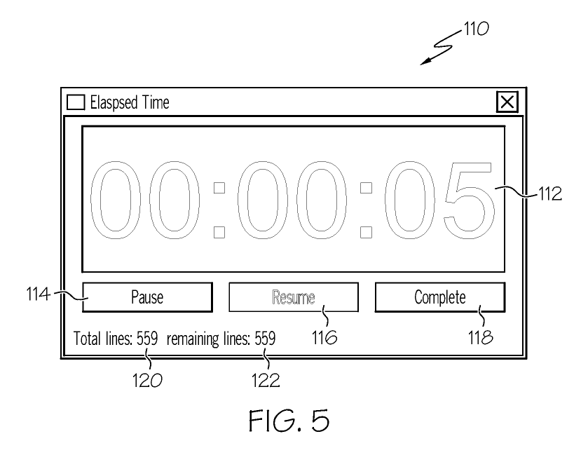

Referring to FIG. 5, one example of a diagram illustrating an inspection rate monitor, according to the exemplary embodiments of the present invention is illustrated. The inspection rate monitor 110 includes a display screen 112, a pause button 114, a resume button 116, and a complete button 118. In addition, the user is informed of the total lines of code 120 in the program and of the remaining lines of code 122 that need to be inspected by the user. Once the inspection begins, the moderator may wish to start the inspection rate monitor by pressing the Inspect button. This starts an elapsed time counter and displays a dialog box 110, which displays the elapsed time and provides buttons to pause 114 the timer and resume 116 the timer, as well as to close it at the end of the inspection with a complete button 118. As the moderator marks items completed, the inspection rate is computed based on the elapsed time. The clock is started at the beginning of the inspection and may be paused and restarted at anytime to support breaks in long running inspections. This inspection rate is compared with a minimum and maximum range defined by the user in the Preference Dialog (shown in FIG. 8 described below) and which is specific to the type of item being inspected. Program code, for instance requires a slower inspection rate than user documentation. The display color may change from green to yellow and then to red as the inspection rate degrades. The dialog may be hidden by other windows, but anytime the color changes it moves to the front to assure the status change is noticed. This allows the moderator to make adjustments to the inspection rate while the inspection is ongoing.

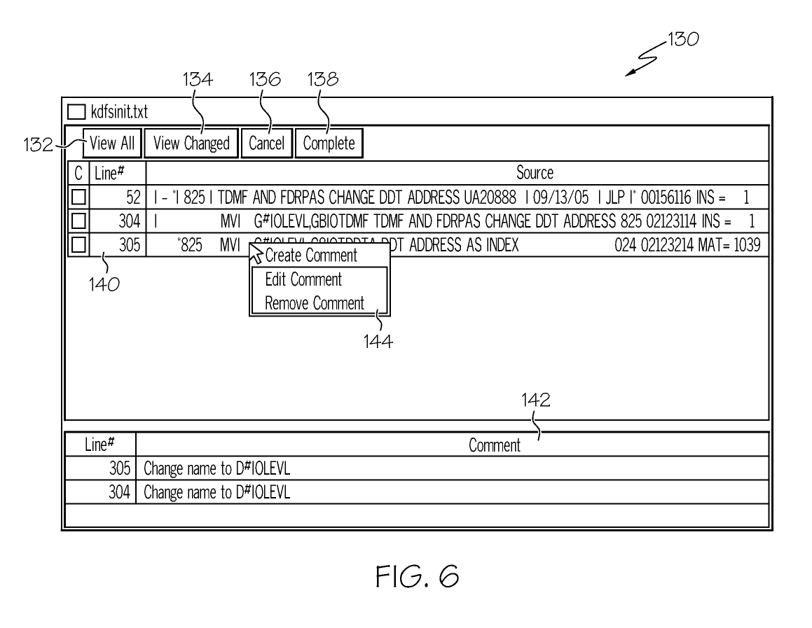

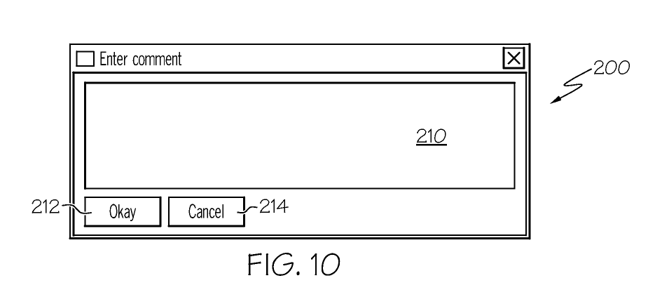

Referring to FIG. 6, one example of a diagram showing a document viewer box in “View Changed” mode with comments, according to the exemplary embodiments of the present invention is illustrated. The document viewer box 130 includes a number of types of information displayed to the user. Specifically, the user may execute the following buttons: a view all button 132, a view changed button 134, a cancel button 136, and a complete button 138. The code modification summary section 140 allows the user to identify the specific line at which a modification has occurred and the source of the modification. The comment section 142 allows the user to incorporate comments with respect to the changes made to the code. The user may right click on the screen of a device employing this software inspection interface and quickly create a comment, edit a comment or remove a comment. It is noted that one may display the above information in any order desired. Moreover, one skilled in the art may be able to identify several additional functions to add to the package contents list window 130 and display a number of other related information. During inspection, all inspectors may open the item currently being examined by clicking the view all button 132, which opens a viewer with two panes. The top pane 140 contains a table view of the item being inspected. The lower pane 142 contains a table of comments against this inspection document. The viewer affords the inspector the opportunity to view the entire item under inspection or just the changed lines. The inspector is also able to enter line specific comments (shown in FIG. 10 described below), which are added to the list, and filed with the package so they can be forwarded back to the author after the inspection is finished. When the viewer is closed by clicking the complete button 138 the item is marked as complete in the package content list and the inspection rate monitor is updated with the total inspected lines.

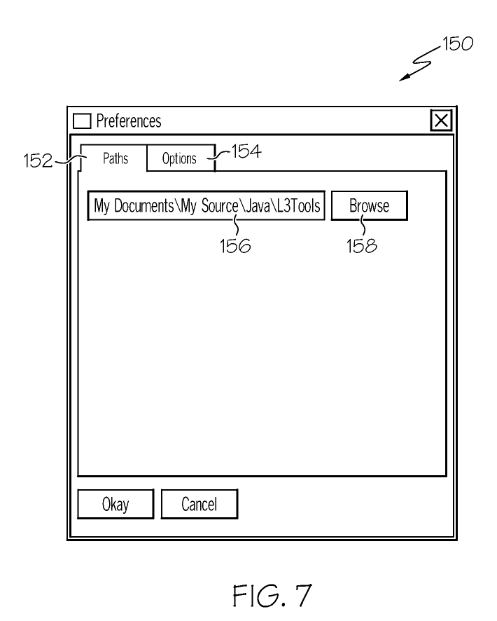

Referring to FIG. 7, one example of a diagram showing a dialog box with a first preference tab, according to the exemplary embodiments of the present invention is illustrated. The first preference tab 150 includes two sub-tabs. The first sub-tab is the paths sub-tab 152 and the second sub-tab is the options sub-tab 154. The first preference tab 150 also shows an inspection directory entry 156 and a browse button 158 for conveniently browsing the directory contains the various codes. The inspection management tool is not limited to the exemplary functions and information displayed in FIG. 7.

Referring to FIG. 8, one example of a diagram showing a dialog box with a second preference tab, according to the exemplary embodiments of the present invention is illustrated. The second preference tab 160 includes two sub-tabs. The first sub-tab is the paths sub-tab 152 and the second sub-tab is the options sub-tab 154 (both also shown in FIG. 7). The second preference tab 160 allows a user, when inspecting code, to mark the progress of inspection by lines completed 162 or to mark the progress by files completed 164. The second preference tab 160 includes an inspection rates section 164. In the inspection rates section 164, the user can monitor the minimum allocated rate of inspection 174 and the maximum allocated rate of inspection 176 of code 168, of documentation 170, and of test scenarios 172.

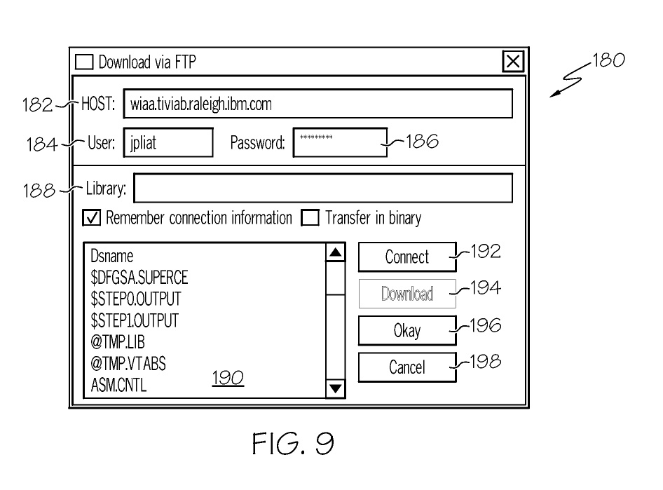

Referring to FIG. 9, one example of a diagram showing a dialog box of a File Transfer Protocol (FTP) download dialog, according to the exemplary embodiments of the present invention is illustrated. The FTP dialog box 180 includes a HOST entry 182, a user entry 184, a password entry 186, and a library entry 188. Window 190 shows a sample listing of files for a particular host and library. The FTP dialog box 180 further includes user functionality, such as a connect button 192, a download button 194, an okay button 196, and a cancel button 198. The FTP download dialog provides, in a manner quite similar to other applications employing this type of function the ability to connect to an FTP server and download files for inclusion in a future code inspection.

Referring to FIG. 10, one example of a diagram showing a dialog box of a comment dialog, according to the exemplary embodiments of the present invention is illustrated. The comment dialog box 200 includes a comment section 210, an okay button 212, and a cancel button 214.

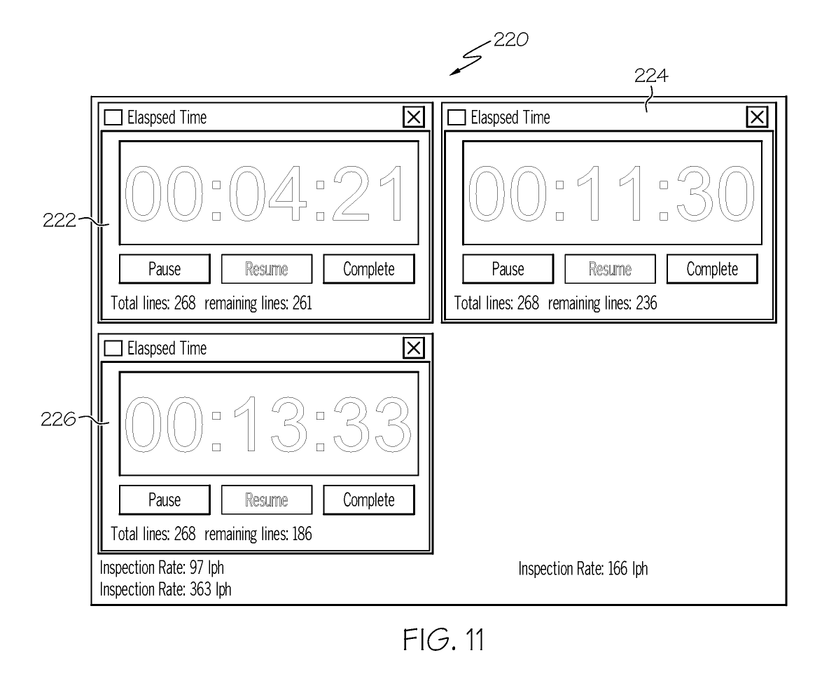

Referring to FIG. 11, one example of a diagram illustrating a plurality of inspection rate monitors showing three possible inspection rate states, according to the exemplary embodiments of the present invention is illustrated. The plurality of inspection rate monitors 220 includes, in an exemplary embodiment, three inspection rate monitors. These are inspection rate monitor 222, inspection rate monitor 224, and inspection rate monitor 226. The green colored text in inspection rate monitor 222 indicates the inspection rate is well within the optimal range for the type of item being inspected. The yellow colored text in inspection rate monitor 224 indicates the inspection rate is falling out of the optimal range for the type of item being inspected. The red colored text in inspection rate monitor 226 indicates the inspection rate is well outside of the optimal range for the type of item being inspected. During the inspection, the user has the option of either marking individual document lines as inspected, or marking entire modules when they are completed. In either case, each time an item is marked as complete, the Inspection Rate Monitor is alerted and the number of inspected lines is updated. This number of lines is divided by the elapsed time to give the current inspection rate. The rate is then compared to user defined minimum and maximum rates for the type of document currently being inspected. As the inspection rate varies outside the desired range, the clock changes color, such as from green to yellow for example, then to red in order to alert the user that the pace of the meeting needs adjusting. For example, a warning threshold of less than 120 lines per hour may be established or a critical threshold of less than 210 lines per hour may be established. The inspection management tool is not limited to the exemplary functions and information displayed in FIG. 11.

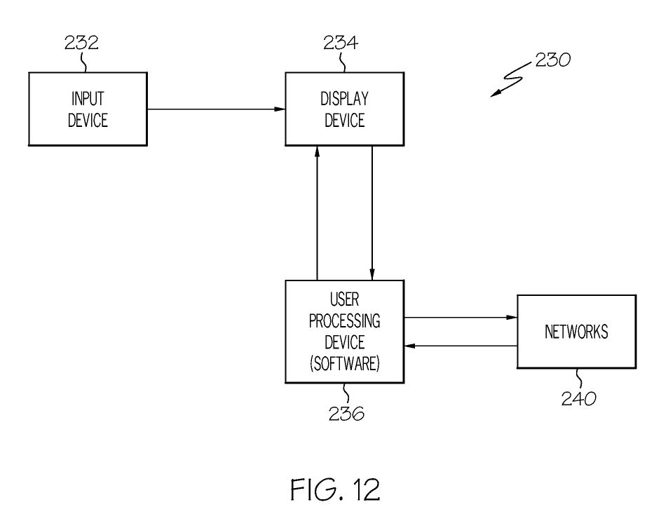

Referring to FIG. 12, one example of a system block diagram 230 showing the system components used to run the inspection tool software is illustrated. The system 230 running the inspection tool software may include an input device 232 in communication with a display device 234. The display device 234 is in communication with a user processing device 236, which includes the inspection tool software or any other types of software. The user processing device 236 may communicate with one or more networks 240. One skilled in the art may use any type of input device, display device, user processing device, or type or network now known or later developed.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A software inspection management tool for monitoring inspection rates of code, the tool comprising:
a display device for displaying a primary window having a plurality of functions, the plurality of functions further comprising:
a first function for defining a new package by inputting an item type, an item language, an item name, and a code status;
a second function for opening an existing package and displaying a plurality of source listings relating to the existing package;
a third function for transmitting the new package or the existing package;
a fourth function for importing and exporting the new package or the existing package; and
an inspection rate monitor for displaying elapsed time of inspection by a user; and
a viewer window having two panes for examining the code, the first pane including a table view of items being inspected and the second pane including a table of comments to be made concerning the items being inspected;
wherein the elapsed time is compared to a predetermined minimum and maximum range of permitted inspection time predefined in a preference dialog window.

2. The tool of claim 1, wherein the plurality of source listings include a file name listing, a total lines of code listing, a code line listing, a comment line listing, a language listing, and a type listing.

3. The tool of claim 1, wherein the primary window is used to retrieve listings from remote locations.

4. The tool of claim 1, wherein the primary window is used to gather information as to whether the new package represents new code or changed code.

5. The tool of claim 1, wherein the preference dialog window allows the user to mark the inspection rate progress by code lines completed.

6. The tool of claim 1, wherein the preference dialog window allows the user to mark the inspection rate progress by files completed.

7. The tool of claim 1, wherein the preference dialog box allows the user to define the permitted inspection time by separately defining maximum and minimum code time, maximum and minimum documentation time, and maximum and minimum test scenario time.

8. The tool of claim 1, wherein the inspection rate monitor includes a pause button, a resume button, a complete button, a total lines inspected indication, and a total lines remaining to be inspected indication

9. The tool of claim 1, wherein color modifications of the elapsed time occur in accordance with the user's inspection rate progress.

10. A system for using a software inspection management tool for monitoring inspection rates of code, the system comprising:
a network; and
a host system in communication with the network, the host system including inspection tool software to implement the system further comprising:
a display device for displaying a primary window having a plurality of functions, the plurality of functions further comprising:
a first function for defining a new package by inputting an item type, an item language, an item name, and a code status;
a second function for opening an existing package and displaying a plurality of source listings relating to the existing package;
a third function for transmitting the new package or the existing package;
a fourth function for importing and exporting the new package or the existing package; and
an inspection rate monitor for displaying elapsed time of inspection by a user; and
a viewer window having two panes for examining the code, the first pane including a table view of items being inspected and the second pane including a table of comments to be made concerning the items being inspected;
wherein the elapsed time is compared to a predetermined minimum and maximum range of permitted inspection time predefined in a preference dialog window.

11. The system of claim 10, wherein the plurality of source listings include a file name listing, a total lines of code listing, a code line listing, a comment line listing, a language listing, and a type listing.

12. The system of claim 10, wherein the primary window is used to retrieve listings from remote locations.

13. The system of claim 10, wherein the primary window is used to gather information as to whether the new package represents new code or changed code.

14. The system of claim 10, wherein the preference dialog window allows the user to mark the inspection rate progress by code lines completed.

15. The system of claim 10, wherein the preference dialog window allows the user to mark the inspection rate progress by files completed.

16. The system of claim 10, wherein the preference dialog box allows the user to define the permitted inspection time by separately defining maximum and minimum code time, maximum and minimum documentation time, and maximum and minimum test scenario time.

17. The system of claim 10, wherein the inspection rate monitor includes a pause button, a resume button, a complete button, a total lines inspected indication, and a total lines remaining to be inspected indication

18. The system of claim 10, wherein color modifications of the elapsed time occur in accordance with the user's inspection rate progress.
